(19) United States
(12) Patent Application Publication
(10) Pub. No.: US 2018/0288024 A1
(43) Pub. Date: Oct. 4, 2018

(54) SECURE MANNER FOR SHARING CONFIDENTIAL INFORMATION

(71) Applicant: Intel Corporation, Santa Clara, CA (US)

(72) Inventors: TAMIR DAMIAN MUNAFO, Naale (IL); GERMAN LANCIONI, SAN JOSE, CA (US); MALKIELA LEDERER, ST. JERUSALEM (IL); GIDI ETZION, CORDOBA (AR)

(21) Appl. No.: 15/475,583

(22) Filed: Mar. 31, 2017

(51) Int. Cl. H04L 29/06; G06F 19/00

(52) U.S. Cl. CPC H04L 63/062; H04L 63/20; G06Q 2220/00; G06F 19/3418; G06F 19/322

(57) ABSTRACT

Sharing patient health information by performing at least the following: generating a temporal access key based on a detection of an event and one or more configuration policies associated with a patient, transferring the temporal access key after authenticating a medical personnel's computing system, and providing access to the patient's health information to the medical personnel's computing system after receiving the temporal access key from the medical personnel's computing system, wherein the one or more configuration policies control the type of health information the temporal access key exposes to the medical personnel's computing system and how the temporal access key expires.

### TECHNICAL FIELD

Embodiments described herein generally relate to sharing confidential data stored on a computing system, and in particular for securely providing patient health information to authorized personnel using electronic user devices, such as wearable devices and/or other smart devices connected to the Internet of Things (IoT).

### BACKGROUND ART

Modern data and computer networks comprise a variety of electronic user devices adapted to collect and exchange data information. Some of these data and computer networks can be generally referred to as IoTs. An IoT environment may include a plurality of physical objects that operate as electronic devices, where each physical object includes embedded electronic components configured to collect and exchange data information. To collect and exchange data information over an IoT environment, the embedded electronic components generally consist of computing hardware and software components, such as microcontrollers, control computing modules, network connectivity, firmware, and/or sensors. The embedded electronic components may also associate each of the physical objects with a unique identifier (e.g., an Internet Protocol (IP) address) such that the physical objects may collect and exchange the data information automatically and without direct human interaction. Examples of physical objects that can communicate within an IoT environment include, but are not limited to wearable devices, building and home automation devices, and/or control and sensory systems.

Although users have continually embraced the concept of wearable devices that monitor and collect health information, users have been reluctant to adopt other types of medical technology that could potentially streamline access to patient health information. For instance, online storage and record keeping of confidential and privileged health information, such as mental health records, mammogram reports, and prescriptions, have failed to gain popularity in the medical industry. Unfortunately, during medical emergencies, the inability to quickly access and obtain patient health information could negatively affect the quality of care a patient receives. In a medical emergency, medical personnel typically search for some form of identification (e.g., a driver license) and subsequently use this information to search multiple databases to retrieve a patient's entire medical record. Alternatively, medical personnel may attempt to fill in potential gaps in a patient's medical record by contacting the patient's family. However, because of the inefficiencies related to releasing private and confidential medical information, medical personnel often waste valuable time retrieving relevant health information (e.g., allergies, blood types, current medication, recent surgeries, and pregnant status) needed to treat a patient during a medical emergency. As such, improving technology that efficiently provides data to authorized personnel while preventing unwarranted access and theft of confidential and/or private information remains valuable in properly managing and securing data.

### BRIEF DESCRIPTION OF DRAWINGS

For a more complete understanding of this disclosure, reference is now made to the following brief description, taken in connection with the accompanying drawings and detailed description, wherein like reference numerals represent like parts.

FIG. 1 is a schematic diagram of an embodiment of a network infrastructure where embodiments of the present disclosure may operate herein.

FIG. 2 is a schematic diagram of an embodiment of a computing system architecture configured to share a patient's medical information with authorized medical personnel.

FIG. 3 is a schematic diagram of another embodiment of a computing system architecture configured to share a patient's medical information with authorized medical personnel.

FIG. 4 is a schematic diagram of another embodiment of a computing system architecture configured to share a patient's medical information with authorized medical personnel.

FIG. 5 is a schematic diagram of an embodiment of a computing system architecture that utilizes a medical cloud service.

FIG. 6 is a flow chart of an embodiment of a method to share a patient's medical information with authorized medical personnel.

FIG. 7 is a flow chart of an embodiment of a method to authenticate a medical personnel and generate a temporal access key using a medical cloud service.

FIG. 8 is a block diagram illustrating an embodiment of a computing device for use with techniques described herein.

FIG. 9 is a block diagram illustrating another embodiment of computing device for use with techniques described herein.

### DESCRIPTION OF EMBODIMENTS

In the following description, for purposes of explanation, numerous specific details are set forth in order to provide a thorough understanding of the invention. It will be apparent, however, to one skilled in the art that the invention may be practiced without these specific details. In other instances, structure and devices are shown in block diagram form in order to avoid obscuring the invention. References to numbers without subscripts or suffixes are understood to reference all instance of subscripts and suffixes corresponding to the referenced number. Moreover, the language used in this disclosure has been principally selected for readability and instructional purposes, and may not have been selected to delineate or circumscribe the inventive subject matter, resort to the claims being necessary to determine such inventive subject matter. Reference in the specification to “one embodiment” or to “an embodiment” means that a particular feature, structure, or characteristic described in connection with the embodiments is included in at least one embodiment of the invention, and multiple references to “one embodiment” or “an embodiment” should not be understood as necessarily all referring to the same embodiment.

As used herein, the term “computing system” can refer to a single electronic computing device that includes, but is not limited to a single computer, host, server, network device, wearable device, mobile device, smart device, and/or any physical object comprising an embedded electronic device or to a plurality of electronic computing devices working together to perform the function described as being performed on or by the computing system.

As used herein, the term “medium” refers to one or more non-transitory physical media that together store the contents described as being stored thereon. Embodiments may include non-volatile secondary storage, read-only memory (ROM), and/or random-access memory (RAM).

As used herein, the term “electronic user device” refers to any physical object that includes electronic components configured to collect and exchange data information. In one embodiment, the electronic user device includes human body communication (HBC) capabilities to transfer health related data in a secure manner via a HBC channel, where the electronic user device is implanted, at least partially implanted, and/or at least in contact with a patient's body (e.g., skin).

The terms “a,” “an,” and “the” are not intended to refer to a singular entity unless explicitly so defined, but include the general class of which a specific example may be used for illustration. The use of the terms “a” or “an” may therefore mean any number that is at least one, including “one,” “one or more,” “at least one,” and “one or more than one.”

The term “or” means any of the alternatives and any combination of the alternatives, including all of the alternatives, unless the alternatives are explicitly indicated as mutually exclusive.

The phrase “at least one of” when combined with a list of items, means a single item from the list or any combination of items in the list. The phrase does not require all of the listed items unless explicitly so defined.

As used herein, the term “wearable device” refers to any physical object worn by a user and configured to transmit and/or receive data over one or more communication environments (e.g., a computer network) and/or one or more connection links (e.g., a universal serial bus (USB) interface). Example embodiments of wearable devices include, but are not limited to smart wristbands that track user activity, smart watches, smart eyewear, and wearable health devices. Unless otherwise specified within this disclosure, the term “wearable device” may be interchanged with and considered synonymous throughout this disclosure to the terms “wearable technology,” “wearable electronic device,” and/or “wearables.”

Unless otherwise specified within the disclosure, the term “patient” may be interchanged with and considered synonymous throughout this disclosure to the term “user.”

Various example embodiments are disclosed herein that gather and provide confidential information (e.g., health information) to one or more authorized personnel. In one embodiment, an electronic user device possessed by a patient is able to provide health information to medical personnel in a specified event, such as when a patient is unable to communicate (e.g., the person is unconscious, there is a language barrier, or the person is a child or is elderly) or is experiencing a health emergency situation. During a predefined situation, medical personnel may trigger the electronic user device by physical contacting (e.g., skin contact) the patient to generate a temporal access key. An HBC component within the electronic user device detects the physical contact by the medical personnel and subsequently has the electronic user device request for medical provider authentication information, such as a medical national provider identifier (NPI) number, to validate medical personnel. Once the electronic user device validates the medical provider authentication information, the electronic user device generates and/or releases a temporal access key to allow the transmission of the patient's vitals and/or other health information to the medical personnel. A patient may implement one or more configuration policies that control and limit the amount of access the temporal access key provides to medical personnel. For example, the configuration policies can be setup to limit a medical personnel's access when using the temporal access key to a specific amount of time, to a particular location, and/or based on the patient's health status (e.g., whether the patient is experiencing a medical emergency). Additionally or alternatively, the configuration policies may allow the medical personnel to access a certain type of patent health information, such as real-time vital information, non-mutable health information (e.g., blood type and allergies), and/or electronic health records when using the temporal access key.

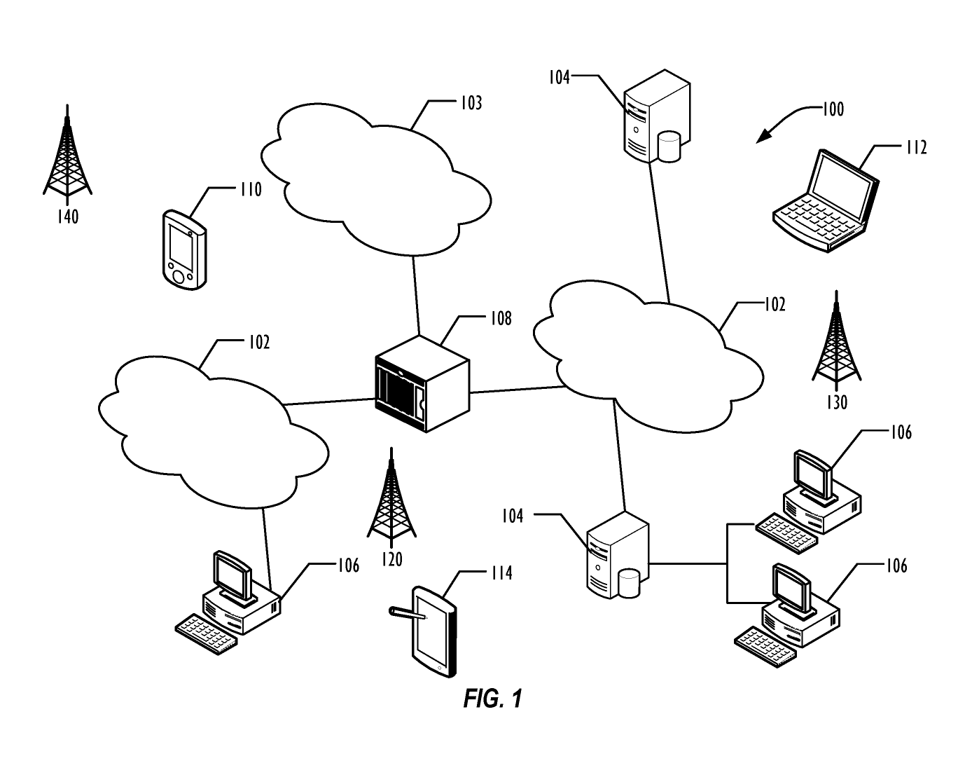

FIG. 1 is a schematic diagram of an embodiment of a network infrastructure 100 where embodiments of the present disclosure may operate herein. Network infrastructure 100 comprises a plurality of computer networks 102. Each of the computer networks 102 may contain a number of other devices typically referred to as Internet of Things (microcontrollers, embedded systems, industrial control computing modules, etc.). Specifically, computer networks 102 comprise one or more different types of computer networks available today, such as the Internet, enterprise networks, data centers, a wide area networks (WAN), and/or a local area networks (LAN). Each of these networks within computer networks 102 may contain wired and/or wireless programmable devices that operator in the electrical and/or optical domain, and also employ any number of network communication protocols (e.g., TCP/IP). For example, one or more of the networks within computer networks 102 may be a wireless fidelity (Wi-Fi®) network, a Bluetooth® network, a Zigbee® network, and/or any other suitable radio based network as would be appreciated by one of ordinary skill in the art upon viewing this disclosure.

The networks within computer networks 102 may also comprise switches, routers, and/or other network hardware devices configured to transport data over computer networks 102. Moreover, one or more of the networks within computer networks 102 may be configured to implement computer virtualization, such as virtual private network (VPN) and/or cloud based networking. FIG. 1 illustrates that computer networks 102 may be connected to computers 106, computer servers 104, and one or more network nodes 108, which include, but are not limited to gateways, routers, and/or wireless access points. In one embodiment, one or more of the computers 106 and/or computer servers 104 may each comprise a plurality of VMs, containers, and/or other types of virtualized computing systems for processing computing instructions and transmitting and/or receiving data over computer networks 102. The computers 106 and computer server 104 may be configured to support a multi-tenant architecture, where each tenant may implement its own secure and isolated virtual network environment. Although not illustrated in FIG. 1, the network infrastructure 100 may connect computer networks 102 to a variety of other types of computing device, such as VMs, containers, hosts, storage devices, electronic user devices (e.g., wearable electronic devices), and/or any other electronic device capable of transmitting and/or receiving data over computer networks 102. The functionality of the network node 108 may be implemented in any device or combination of devices illustrated in FIG. 1; however, most commonly is implemented in a firewall or intrusion protection system in a gateway or router.

As shown in FIG. 1, network infrastructure 100 may also comprise a cellular network 103 for use with mobile communication devices. The cellular network 103 may be capable of supporting of a variety of electronic devices that include, but are not limited to computers, laptops, wearable electronic devices, mobile devices (e.g., mobile phones) and/or electronic user devices. Using FIG. 1 as an example, electronic devices in the network infrastructure 100 may communicate via the cellular network 103 are illustrated as mobile phones 110, laptops 112, and tablets 114. A mobile device, such as mobile phone 110, may interact with one or more mobile provider networks as the mobile device moves, typically interacting with a plurality of mobile network towers 120, 130, and 140 for connecting to the cellular network 103. Although referred to as a cellular network 103 in FIG. 1, a mobile device may interact with towers of more than one provider network, as well as with multiple non-cellular devices such as network node 108. In addition, the mobile devices 110, 112, and 114 may interact with non-mobile devices such as computers 104 and computer servers 106 for desired services.

In one or more embodiments, one or more mobile devices 110, 112, and 114, computer servers 104, computers 106, and/or other computing systems may support trusted operations through the employment of a trusted execution environment (TEE). For example, a TEE may be implemented using a hardware manageability engine, computing chipset, and/or other separate computing logic unit. Additionally or alternatively, a TEE may be implemented using secure enclaves, such as Intel's Software Guard Extensions (SGX) technology. In one embodiment, the computing system, such as mobile devices 110, 112, and 114, computer servers 104, and computers 106, in network infrastructure 100 may implement trusted discovery that allows trusted network devices to discover other trusted network devices, or trusted network nodes, that include a trusted entity. Trusted discovery may be necessary to reveal additional trusted capabilities and services among trusted devices. Some examples of protocols that may be revealed only by trusted discovery include attestation, key agreement, group formation, trusted proxy, and provisioning.

In one or more embodiments, one or more mobile devices 110, 112, and 114 and/or other types of electronic user devices (e.g., wearable devices) provide temporary access to confidential and/or private user information because of an occurrence of a specified event, such as a scheduled medical appointment and/or medical emergency. In one embodiment, the mobile devices 110, 112, and 114 and/or other types of electronic user devices may simplify and mitigate the information access barrier generally associated with accessing a patient's health information. The mobile devices 110, 112, and 114 and/or other types of electronic user devices include HBC capabilities that transfer a temporal access key and/or other data via the patient's body. The temporal access key associated with a patient can be transferred to a medical personnel's computing system, such as computer servers 104 and/or computers 106. The medical personnel's computing system, which also have HBC capabilities, uses the temporal access key to access and collect certain health information for a limited duration. In one embodiment, the patient is able to setup, prior to specified event, one or more configuration policies stored on the mobile devices 110, 112, and 114 and/or other types of electronic user devices to control the type of health information and/or duration the medical personnel's computing system is able to access the patient's health information when using the temporal access key.

One illustrative example of simplifying and mitigating the information access barrier generally associated with accessing a patient's health information occurs in a context of a medical emergency. During a medical emergency, a patient can be in an unconscious state when the first medical personnel arrive to start life-saving treatment. For the medical personnel to provide effective treatment, the medical personnel receives a temporal access key from the patient's mobile device 110, 112, and 114 and/or other type of HBC-enabled electronic user device (e.g., wearable device) to access certain health information. Prior to generating the temporal access key, the patient's mobile device 110, 112, and 114 and/or other type of HBC-enabled electronic user device may request and authenticate the medical personnel's computing system using medical provider authentication information, such as a medical NPI. After detecting that a medical emergency exists and authenticating the medical personnel, the patient's mobile device 110, 112, and 114 and/or other type of HBC-enabled electronic user device generates and provides the temporal access key to the medical personnel's computing system. After receiving the temporal access key, the medical personnel's computing system uses the temporal access key to receive the transmission of health information from the patient's electronic user device and/or a remote computing system (e.g., cloud storage) for as long as the medical emergency exists. Other illustrative examples of events that utilize a temporal access key to share patient health information could include scheduled medical appointments and/or any other situation where a patient may require medical attention.

The generated temporal access key may be associated with one or more configuration policies that control the type of health information the medical personnel's computing system receives and/or the duration of time the temporal access key remains valid. To determine the type of health information a medical personnel's computing system is able to access, the configuration policies may initially categorize a patient's health information into different levels. Below is a non-limiting example of different levels of configuration policies that could categorize a patient's health information:
Level 1 (L1): real-time patient vital information, such as pulse rate, temperature, respiration rate, and blood pressure;
Level 2 (L2): non-mutable health information, such as patient's blood type and allergies; and
Level 3 (L3): electronic health records that include current drug prescriptions and recent surgeries.
   Utilizing the medical emergency example discussed above, the configuration policies could allow the medical personnel's computing system to access L1 real-time patient vital information and L2 non-mutable health information, but may not provide access to L3 electronic health records of the patient. Other configuration policies may be established as desired.

The configuration policies may also define how long the temporal access key is valid and/or when the temporal access key becomes invalid. For example, the configuration policies may specify an amount of time the temporal access key remains valid (e.g., an hour), one or more locations the temporal access key becomes invalid (e.g., when entering the hospital or moving the patient more than a threshold distance from where the temporary access key was made valid, the temporal access key will be dismissed) and/or one or more locations the temporal access key remains valid (e.g., temporal access key remains valid only at a specific medical facility), based on the patient health status (e.g., temporal access key becomes invalid if a patient is able to communicate or is out of danger) or combinations thereof. Once a specified duration elapses and/or the specified event for generating the temporal access key no longer exists, the temporal access key expires and the medical personnel's computing system no longer has access to the patient's health information.

In one embodiment, the patient's health information may be exchanged between computing systems using a TEE to enhance data security and protection. The TEE may utilize encryption and/or authentication technologies to encrypt the patient's health information. For example, the patient's mobile device 110, 112, and 114 and/or other type of electronic user device may generate the temporal access key and/or other security keys within a TEE environment. In addition to utilizing the temporal access key to gain access to the patient's health information, the patient's mobile device 110, 112, and 114 and/or other type of electronic user device may use the temporal access key to encode the actual health information transmitted to the medical personnel's computing system. Other embodiments, may use other security keys shared between computing systems to encrypt the patient's health information. Examples of data encryption techniques known by persons of ordinary skill in the art used to encrypt patient information include, but are not limited to Secure Hash Algorithm 2 (SHA-2), message-digest 5 (MD5), and Secure Hash Algorithm 3 (SHA-3).

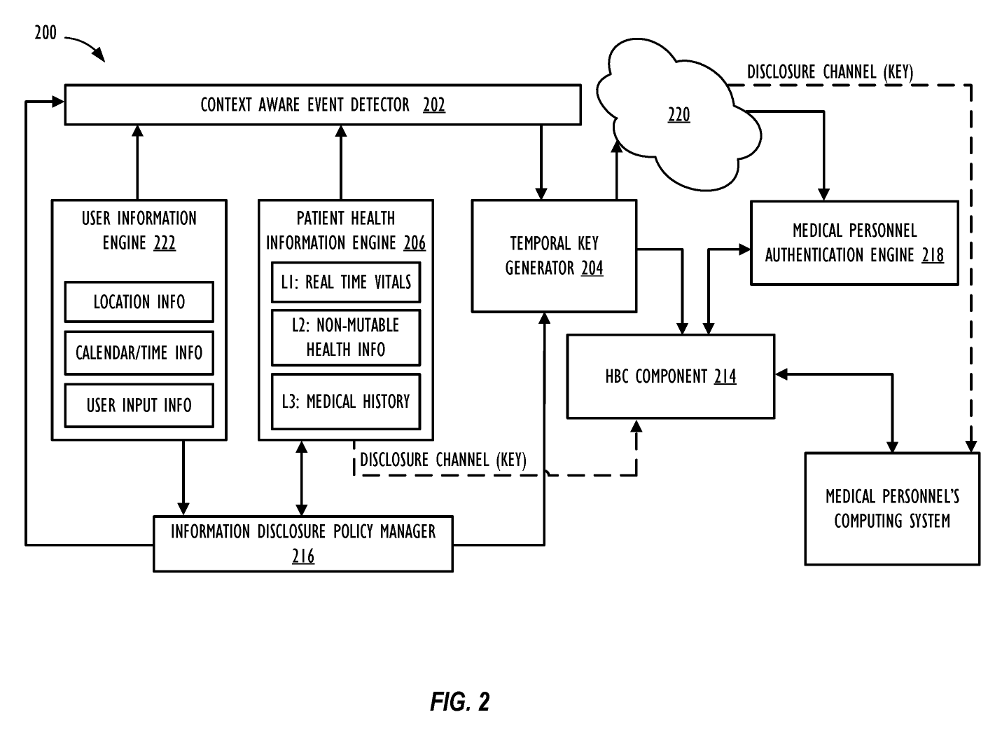

FIG. 2 is a schematic diagram of an embodiment of a computing system architecture 200 configured to share a patient's medical information with authorized medical personnel. The computing system architecture 200 may be implemented within a single local electronic user device or as a computing system that includes a local electronic user device and one or more remote computing devices (e.g., cloud services). Using FIG. 1 as an example, a local electronic user device may implemented using one or more of the mobile devices 110, 112, and 114 and the remote computing devices may be implemented using computer servers 104 and/or computer 102. Portions of the computing system architecture 200 may also be implemented in a TEE to enhance security and privacy. For instance the temporal key generator 204 may be located within a TEE, such as a hardware manageability engine and/or using secure enclaves.

As shown in FIG. 2, the computing system architecture 200 includes a context aware event detector 202, patient health information engine 206, and a user information engine 222. The patient health information engine 206 may be configured to poll a patient's health information, such as real-time vitals, non-mutable health information, and electronic health records, from different sensors, local memory, and/or remote computing storage systems and send at least a portion of the patient's health information (e.g., real-time vitals) to the context aware event detector 202. The user information engine 222 may poll a variety of user information related to medical-based events, such as user input, calendar information, location information, and/or time information and send the user information to the context aware event detector 202. The user information engine 222 may obtain the user information from local memory and/or remote computing storage systems.

The context aware event detector 202 is configured to detect a specified event that allows for the generation of a temporal access key and/or triggers the invalidation of a generated temporal access key based on data obtained from the patient health information engine 206, the user information engine 222, and configuration policies from the information disclosure policy manager 216. The context aware event detector 202 may receive configuration policies that determine when specified events occur that allow for generation of a temporal access key. Examples of events that could cause generating a notification to the temporal key generator 204 to allow generation of a temporal access key include medical emergencies, scheduled medical visits, and/or other types of events related to a patient seeking medical attention. The context aware event detector 202 may also detect when these events no longer exist or a duration of time elapses that causes expiration of the temporal access key. In one embodiment, the configuration policy may be used to create threshold limits that when satisfied indicate the occurrence of a specified event.

In one embodiment, the context aware event detector 202 may use patient health information received from the patient health information engine 206 to detect whether a specified event, such as a medical emergency, allows for the generation of a temporal access key. For example, the context aware event detector 202 receives real-time vital information, such as pulse rate, temperature, respiration rate, blood pressure, and/or electronic health records from the patient health information engine 206. After receiving the patient health information, the context aware event detector 202 may determine that a medical emergency may exist when detecting that the real-time respiration rate and/or pulse rate for a patient drops below minimum threshold values. When the context aware event detector 202 determines that the minimum threshold is satisfied, the context aware event detector may send a notification to the electronic user device that the medical emergency does not exist. If the patient provides a user input (e.g., pressing a button) to dismiss the medical emergency notification, then the context aware event detector 202 does not generate a notification to allow for generation of a temporal access key. Conversely, if the patient fails to provide a user input to dismiss the medical emergency notification for a predetermined amount of time (e.g., about five seconds), then the context aware event detector 202 may allow for the generation of a temporal access key. Additionally or alternatively, the context aware event detector 202 may use medical history information to reduce the likelihood that measured respiration rate and/or pulse rate are a false alarm and/or are caused from sensor errors. For example, the context aware event detector 202 may analyze information from the patient health information engine 206 to determine that the patient has a pre-existing medical condition that could cause a medical emergency that drops the respiration rate and/or pulse rate below minimum threshold values.

In another embodiment, the context aware event detector 202 may obtain a variety of user information, such as user input (e.g., from a user interface), user location information (e.g., global positioning satellite (GPS) information), user calendar information, and time information from user information engine 222 to detect medical-based events that would benefit from sharing a patient's medical information. For example, the context aware event detector 202 may receive user calendar information that indicates a patient is scheduled for a medical visit at a particular time and location. The context aware event detector 202 may receive current user location information and time information from the user information engine 222. The context aware event detector 202 may then use the user location information and time information to determine that a patient has arrived at the designated medical facility around the designated time identified recorded within the user calendar information. At this point, the context aware event detector 202 may generate and send a notification to the temporal key generator 204 to allow for the generation of the temporal access key for the scheduled medical visit.

FIG. 2 also illustrates that the computing system architecture 200 includes an information disclosure policy manager 216 that provides one or more configuration policies to the temporal key generator 204. In one embodiment, a patient may create configuration policies prior to a specified event that controls the type of health information an electronic user device exposes for a specified event. As shown in FIG. 2, a patient may create configuration policies that categorize a patient's health information obtained from the patient health information engine 206 into three different levels, L1, L2, and L3. In FIG. 2, L1 refers to real-time patient vital information; L2 refers to non-mutable health information; and L3 refers to recorded medical history, such as electronic health records. For emergency based events, the configuration policies may allow the medical personnel's computing system to access L1 and L2 health information but may not provide access to L3 health information for the patient. For a scheduled medical visit, the patient may create configuration policies that provide L2 and L3 health information. Other embodiments may have the configuration polices categorize the patient's health information using a different number of levels and/or using different data classifications.

The information disclosure policy manager 216 allows a patient to create configuration policies that control how the temporal access key expires or becomes invalid. Stated another way, the configuration policy may create expiration conditions that when met, invalidate the temporal access key. As shown in FIG. 2, the information disclosure policy manager 216 is able to receive user information from user information engine 222 and create configuration policies based on the user information. For example, a patient may set up the configuration policies to specify one or more locations the temporal access key becomes invalid (e.g., when entering the hospital the temporal access key will be dismissed) and/or one or more locations the temporal access key remains valid (e.g., temporal access key remains valid only when a patient is at a specific medical facility where once the patient leaves, the temporal access keys becomes invalid). The location information used to create the configuration policies could be obtained from previously stored user location information and/or user calendar information. In another example, the configuration policies may be set up such that when a user inputs a specific code or provide specific information via an input interface (e.g., a touchscreen) one or more of the temporal access keys become invalid (or valid).

Additionally or alternatively, the information disclosure policy manager 216 may create configuration policies without utilizing user information, such as creating configuration policies that specify an amount of time the temporal access key remains valid (e.g., an hour) and/or the patient's current health condition (e.g., temporal access key becomes invalid if a patient is able to communicate or is out of danger). Once a specified duration elapses and/or the specified event for generating the temporal access key no longer exists, the temporal access key expires and a medical personnel's computing system may no longer have access to patient's health information. The information disclosure policy manager 216 may send configuration policies to both the temporal key generator 204 and context aware event detector 202 to control when and/or how the temporal access key expires or becomes invalid.

The computing system architecture 200 also includes a medical personnel authentication engine 218 that authenticates whether the medical personnel's computing system is authorized to receive the patient's health information. In one embodiment, the medical personnel authentication engine 218 may request and receive medical provider authentication information, such as a medical NPI, and locally authenticate the medical provider authentication information. For example, the medical personnel authentication engine 218 may query a remote computing service 220 for an updated list of approved medical provider authentication information and subsequently locally store the updated list. When the medical personnel authentication engine 218 receives medical provider authentication information from the HBC component 214, the medical personnel authentication engine 218 may authenticate the received medical provider authentication information using the updated list. In another embodiment, the medical personnel authentication engine 218 may forward the medical provider authentication information to the remote computing service 220 for authentication. After receiving the medical provider authentication information, the remote computing service 220 may respond back with authentication results to the medical personnel authentication engine 218. Other embodiments of the medical personnel authentication engine 218 may implement other types of authentication operations known by persons of ordinary skill in the art to authenticate users.

The temporal key generator 204 receives notifications from the context aware event detector 202 to allow for generation of the temporal access keys and configuration policy information from the information disclosure policy manager 216 that defines the scope of access for the temporal access key. In one embodiment, the temporal key generator 204 may operate in a TEE within a local electronic user device. The TEE may be logically isolated from computing applications (e.g., client software) operating on the electronic user device to prevent computing applications from accessing protected content, such as temporal access keys. To logically isolate the temporal key generator 204 from the computing application 205, the TEE can be implemented using a separate hardware security and management engine, such as Intel's Manageability Engine (ME), or other TEE technology, such as secure enclaves (e.g., Intel's SGX technology). In one embodiment, the temporal key generator 204 uses the configuration policy information to define a duration of time the generated temporal access key is valid for and/or any conditions when met causes the temporal access key to expire.

In one embodiment, the temporal key generator 204 may generate a temporal access key based on assistance from one or more remote computing devices located within the remote computing service 220 (e.g., medical cloud service). The temporal key generator 204 may receive assistance from the remote computing service 220 when relevant patient health information is stored on the remote computing service 220. To generate the temporal access key, once the remote computing service 220 authenticates the medical personnel's computing system using the information provided by the medical personnel authentication engine 218, the temporal key generator 204 may receive a remote access key from the remote computing service 220 that enables the patient health information engine 206 to access a patient's health information stored on the remote computing service 220. The temporal key generator 204 may then assign the received remote access key as the temporal access key and provide the temporal access key to the medical personnel's computing system via the HBC component 214. In this instance, the medical personnel's computing system provides the temporal access key to the remote computing service 220 to obtain relevant patient information stored on the remote computing service 220.

Although not illustrated in FIG. 2, in one or more embodiments, the computing system architectures 200 could have the medical personnel authentication engine 218 receive configuration policies, event information, and/or temporal access key information to authenticate the medical personnel's computing system. Rather than having the remote computing service 220 authenticate medical personnel, the medical personnel authentication engine 218 may independently manage and/or obtain a list of approved medical provider authentication information based on the received event information, configuration policies, and/or temporal access key information. For example, in instances where the patient's health information is accessible for a scheduled medical visit, the medical personnel authentication engine 218 may obtain event information relating to the scheduled medical visit. From the event information, the medical personnel authentication engine 218 may determine a medical provider for the scheduled medical visit. The medical personnel authentication engine 218 may also determine that the temporal access key for the scheduled medical visit is set to expire after completing the scheduled medical visit. Based on this information, the medical personnel authentication engine 218 may update the list of approved medical provider authentication information to include only the specific medical provider for the scheduled medical visit. By doing so, the medical personnel authentication engine 218 may be able to authenticate medical providers without using the remote computing service 220.

The HBC component 214 facilitates the transfer of health information (e.g., patient vitals), the temporal access key, and medical provider authentication information between an electronic user device and the medical personnel's computing system via the patient's body. In other words, the HBC component 214 incorporates human body communication technology known by persons of ordinary skill in the art to transfer data in a wireless manner between the electronic user device and the medical personnel's computing system. For example, to create an HBC channel to facilitate the transfer of data, the skin of the patient and medical personnel are in contact with each other. The patient's body acts as the HBC channel where the HBC component 214 transfers magnetic signals encoded with the temporal access key between the electronic user device and the medical personnel's computing system. One advantage of using a HBC component 214 rather than a near-field communication-based component is that medical personnel does not need to physically locate and access the electronic user device, which can be hidden and/or inaccessible, to retrieve medical information. The HBC component 214 eliminates the need to physically locate a patient's electronic user device by creating the HBC channel through the physical contact of the medical personnel's and patient's skin. In one embodiment, the HBC component 214 may transfer encrypted and/or signed data using the temporary access key and/or other security keys. In specified events that allow for generation of the temporal access key, the HBC component 214 also detects when medical personnel has touched the patient to trigger a request to authenticate the medical personnel's computing system. Although not illustrated within FIG. 2, the medical personnel's computing system also includes an HBC component to facilitate the transfer of data using the HBC channel.

As discussed above, for the HBC component 214 to communicate and exchange data with the HBC component in the medical personnel's computing system, the patient's body and medical personnel's body act as a bus or communication channel (e.g., HBC channel). In one embodiment, once the HBC component 214 receives the temporal access key from the temporary key generator 204, the HBC component 214 transfers the temporal access key via a HBC channel to the medical personnel's computing system. The medical personnel's computing system, which also includes a similar HBC component (not shown in FIG. 2), may then provide the temporal access key back to the HBC component 214 to gain access to the patient's health information until the temporal access key expires. When a temporal access key expires based on an occurrence of a specified event, the context aware event detector 202 may send a notification that informs the temporal key generator 204 the detection of a specified event that caused one or more temporal access keys to expire. Once the temporal key generator 204 receives this notification, the temporal key generator 204 may use the event information within the notification to determine which temporal access keys should no longer be valid. The temporal key generator 204 may then notify the HBC component 214 that certain temporal access keys are no longer valid. When the HBC component 214 receives the notification regarding the expired temporal access keys, the HBC component 214 stops any ongoing and future access and distribution of the patient's health information to the medical personnel's computing system using the expired temporal access key.

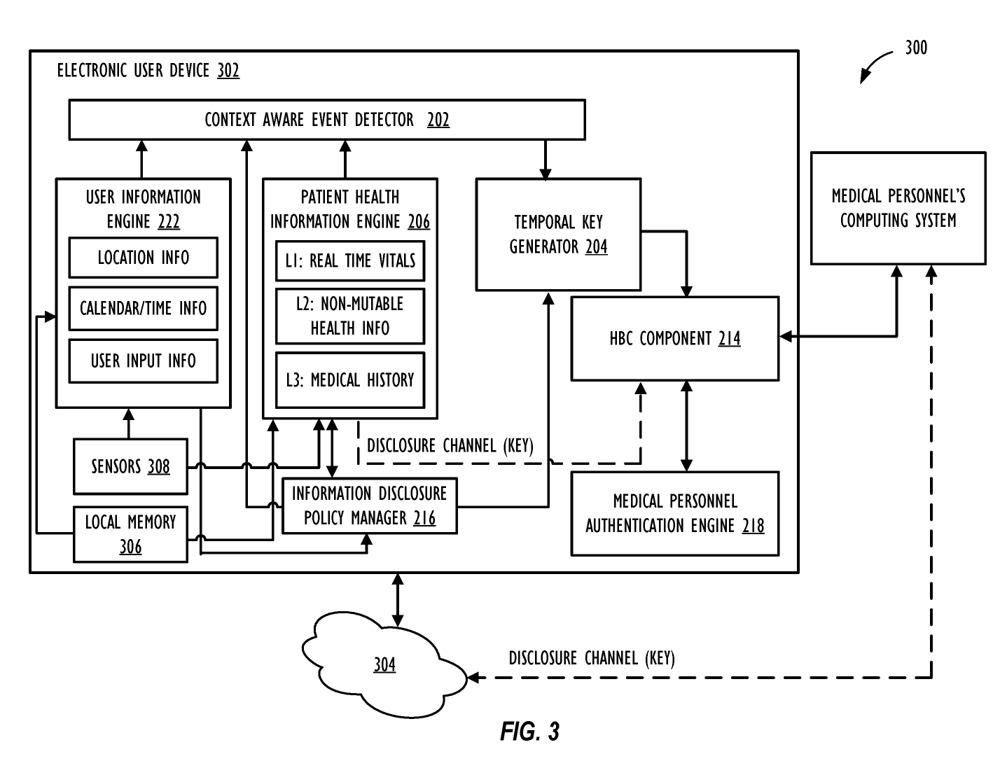

FIG. 3 is a schematic diagram of another embodiment of a computing system architecture 300 configured to share a patient's medical information with authorized medical personnel. As shown in FIG. 3, the context aware event detector 202, the temporal key generator 204, the patient health information engine 206, the user information engine 222, information disclosure policy manager 216, HBC component 214, and medical personnel authentication engine 218 are located within a single electronic user device 302. In one or more embodiments, the temporal key generator 204 and/or medical personnel authentication engine 218 may be implemented within a TEE. FIG. 3 also illustrates that the electronic user device 302 may exchange data with a network 304. The network 304 may include medical cloud services that provide health information and/or perform a variety of authentication operations for the electronic user device 302. For example, the network 304 could include the remote computing service 220 described in FIG. 2 that authenticates the medical personnel's computing system, assists in generating the temporal access key, and/or stores patient health information. As shown in FIG. 3, network 304 may provide patient health information stored in network 304 once the medical personnel's computing system provides the temporal access key to the network 304. The amount and type of data retrieved via network 304 may vary depending on the amount of computing resources and power contained within the electronic user device 302.

In FIG. 3, the user information engine 222 and patient health information engine 206 may poll data from network 304, sensors 308 and/or local memory 306. In particular, the user information engine 222 is able to poll user information related to medical-based events from one or more sensors 308 and/or local memory 306. For example, the user information engine 222 may obtain user location information from a GPS sensor and/or user calendar information stored in local memory 306. Additionally or alternatively, the user information engine 222 may poll user information from a network 304 (e.g., cloud services), such as a history of user locations and/or calendar information stored in the cloud. The patient health information engine 206 may be configured to poll patient's health information stored in local memory 306 and/or real-time vitals obtained from sensors 308. Sensors 308 may be an aggregation of sensors that detect medical-based information (e.g., blood pressure or heartbeat rate), emergency based information (e.g., fall detection, lack of movement, and crash detection), and/or user information (e.g., location information). Additionally or alternatively, the patient health information engine 206 may poll for the patient's health information, such as portions of the patient's electronic health record, from network 304.

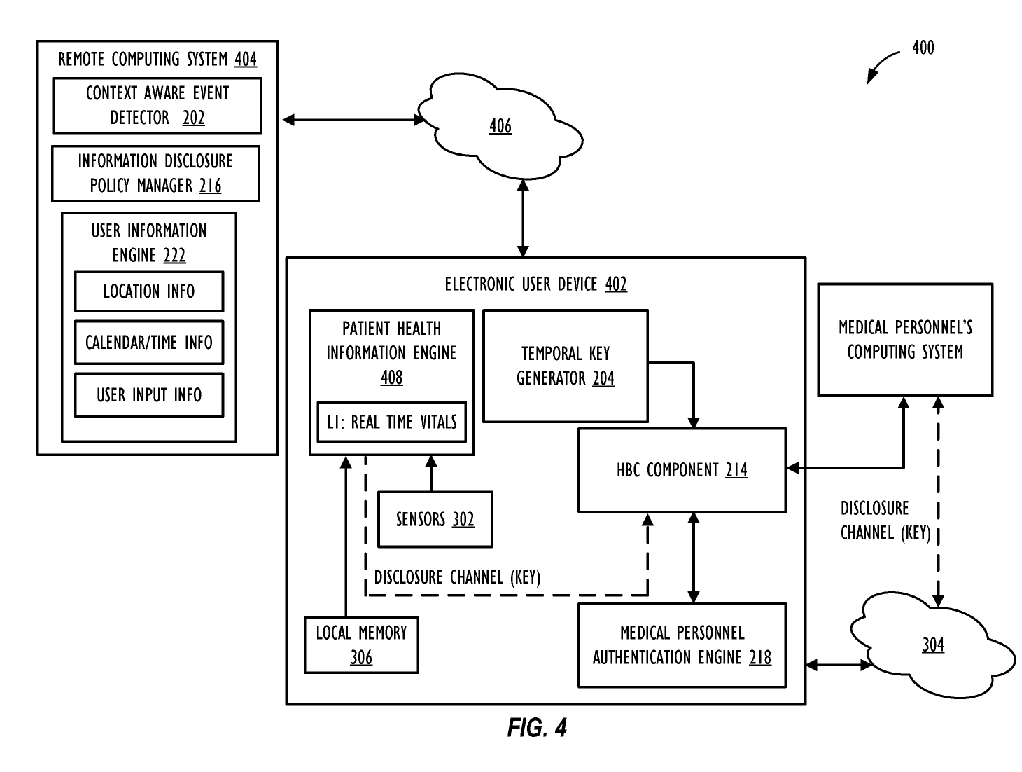

FIG. 4 is a schematic diagram of another embodiment of a computing system architecture 400 configured to share a patient's medical information with authorized medical personnel. As shown in FIG. 4, the computing system architecture 400 includes an electronic user device 402 that is connected to a remote computing system 404 via network 406. The network 406 is configured to exchange communications between the electronic user device 402 and the remote computing system 404. The electronic user device 402 includes the temporal key generator 204, the patient health information engine 408 that polls real-time vitals, the HBC component 214, and the medical personnel authentication engine 218. The remote computing system 404 includes the context aware event detector 202, information disclosure policy manager 216, and user information engine 222. The context aware event detector 202, information disclosure policy manager 216, and user information engine 222 may be moved to the remote computing system 404 because of the amount of computing resources and power contained within the electronic user device 402. In this instance, performing relatively more complex computing operations, such as detecting events and/or defining user policy configuration may be offloaded to the remote computing system 404 that has more computing resources.

As a non-limiting example, the electronic user device 402 is a device with limited computing power and resources, such as a smart watch, and the remote computing system 404 is a device with relatively more computing power and resources than the electronic user device 402, such as a smart phone. In this example, the network 406 is a Bluetooth® network that exchanges communication between the electronic user device 402 and remote computing system 404. The electronic user device 402 collects real time vital information, such as pulse rate and/or temperature, and sends the real time vital information to the context aware event detector 202 located in the remote computing system 404. Using the real-time vital information and user information engine, the context aware event detector 202 may detect the occurrence of a specified event that allows for the generation of a temporal access key. The remote computing system 404 may generate and transmit a notification to the electronic user device 402 notifying the temporal key generator 204 of the specified event and configuration policies associated with the generation of a temporal access key based on the specified event. Once the electronic user device 402 authenticates the medical personnel's computing system, the HBC component 214 may send the temporal access key to medical personnel's computing system.

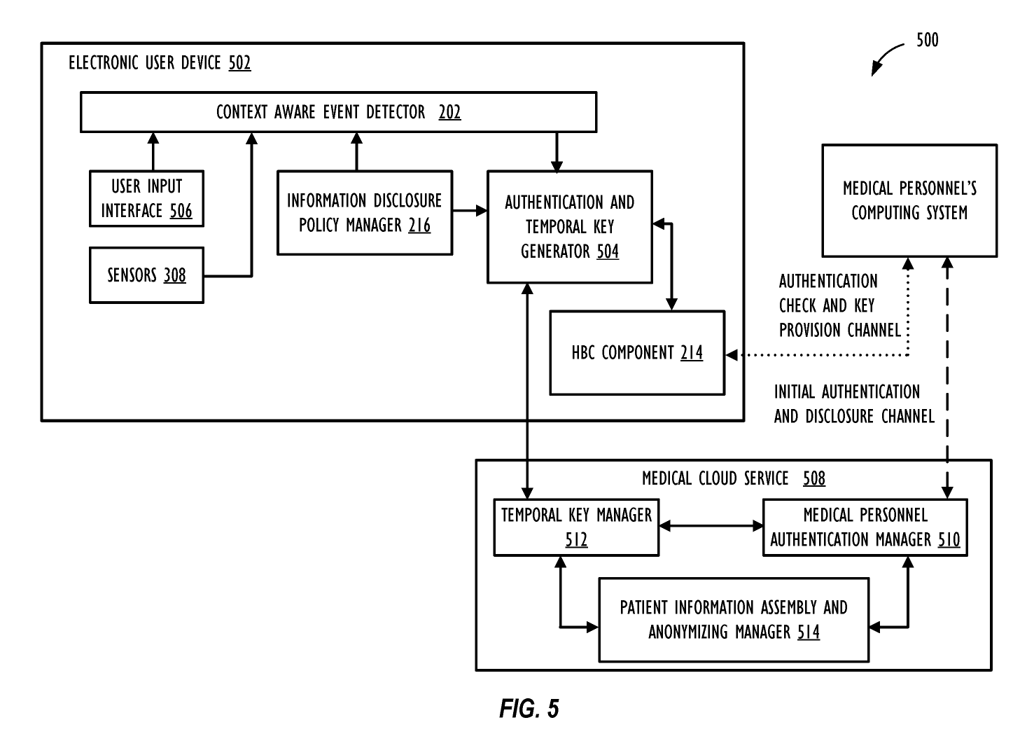

FIG. 5 is a schematic diagram of an embodiment of a computing system architecture 500 that utilizes a medical cloud service 508. The electronic user device 502 includes, information disclosure policy manager 216, an authentication and temporal key generator 504, user input interface 506, sensors 308, and HBC component 214. The medical cloud service 508 includes a temporal key manager 512, a medical personnel authentication manager 510, and a patient information assembly and anonymizing manager 514. The authentication and temporal key generator 504 and the temporal key manager 512 may exchange information and work together to create a temporal access key. For instance, the authentication and temporal key generator 504 may provide configuration information to the temporal key manager 512 when generating a temporal access key. The medical personnel authentication manager 510 may act as a gateway to determine whether the temporal access key provided by the medical personnel's computing system is valid and to initially authenticate the medical personnel's computing system. The patient information assembly and anonymizing manager 514 provides the patient's health related information to the medical personnel's computing system while obfuscating or removing a patient's personal identifiable information (e.g., patient's name, social security number, and address information).

As a non-limiting example, the context aware event detector 202 may use sensors 308 to detect when a patient enters and exits an emergency situation. Sensors 308 may be an aggregate of sensors that obtain health based information, event based information, and/or user information. Example of information the sensors 308 may obtain to determine the probability of emergency include, but are not limited to blood pressure, heart beat rate, fall detection, patient lack of movement, crash detection, and/or user location. When the context aware event detector 202 determines that, based on the sensor data, an emergency threshold is satisfied, the context aware event detector 202 may generate a notification to a user interface to confirm whether the emergency actually exists or not. For example, the notification requests that a patient via the user input interface 506 confirm whether a medical emergency exists. If the patient provides a user input via the user input interface 506 that dismisses the emergency, then context aware event detector 202 will terminate the detected emergency. If the patient fails to provide user input to dismiss the notification, then the context aware event detector 202 sends an emergency response notification to the authentication and temporal key generator 504 to allow generation of the temporal access key. In instances where an emergency response notification was not previously generated, any physical contact by the medical personnel would simply be ignored and would not generate a request for medical authentication information. In other words, when the context aware event detector 202 does not detect a medical emergency, any communication signals received by the HBC component 214 can be treated as noise.

Once the authentication and temporal key generator 504 receives the emergency response notification, if a medical personnel physically contacts the patient, the HBC component 214 may recognize the physical contact and request an authenticity token from the medical personnel's computing system. To obtain the authenticity token, the medical personnel's computing system may transmit a request to the medical personnel authentication manager 510 within the medical cloud service 508. In one embodiment, the request can include medical authentication information, such as a fingerprint scan and/or medical NPI number. After the medical personnel authentication manager 510 verifies that the medical personnel's computing system is valid, the medical personnel authentication manager 510 may generate an authenticity token that is sent back to the medical personnel's computing system. The medical personnel's computing system receives the authenticity token and forwards it via an HBC channel to the authentication and temporal key generator 504. The authentication and temporal key generator 504 pushes the authenticity token received from the medical personnel's computing system to the temporal key manager 512 in the medical cloud service 508 for verification.

As shown in FIG. 5, the temporal key manager 512 receives the authenticity token from the medical personnel authentication manager 510. The temporal key manager 512 compares the authenticity token received from the medical personnel authentication manager 510 with the authenticity token received from the authentication and temporal key generator 504. If the authenticity token matches and/or is determined to be valid, the temporal key manager 512 generates a temporal access key and transfers the temporal access key back to the authentication and temporal key generator 504, which then forwards the temporal access key to the medical personnel's computing system. As part of the temporal access key generation, the medical cloud service 508 may obtain configuration policies from the authentication and temporal key generator 504, within the medical cloud services 508, and/or some other remote computing system to enforce what type of patient information to provide and the temporal access key's expiration condition. Embodiments may provide audit logs for the temporary access key generation and transmittal for later review.

The medical personnel's computing system may obtain the patient's information from the medical cloud service 508 using the temporal access key. After validating the authenticity token received from the electronic user device 502, the patient information assembly and anonymizing manager 514 may create a temporal and anonymized collection of patient information according to configuration policies. In one embodiment, the patient information assembly and anonymizing manager 514 receives the temporal access key from the temporal key manager 512 and uses the temporal access key to encrypt the temporal and anonymized collection of patient information. Once the context aware event detector 202 detects an expiration condition and notifies the authentication and temporal key generator 504, the authentication and temporal key generator 504 may communicate with the temporal key manager 512 to notify that the temporal access key has become invalid. The temporal key manager 512 may then notify the patient information assembly and anonymizing manager 514 to delete the temporal and anonymized collection of patient information from the medical cloud service 508.

As persons of ordinary skill in the art are aware, although FIGS. 2-5 illustrate specific embodiments of implementing computing system architectures 200, 300, 400, and 500, the disclosure is not limited to the specific embodiments illustrated in FIGS. 2-5. For instance, although FIGS. 2-5 pertain to gathering health information, the computing system architectures 200, 300, 400, and 500 may also be applicable to gathering other types of confidential and/or private information. Moreover, other embodiments of the present disclosure may combine one or more of the system components into a single system component. Using FIG. 2 as an example, the temporal key generator 204, the HBC component 214, and the medical personnel authentication engine 218 may be implemented as a single system component, such as a secure embedded controller. In another instance, one or more system components may be located within other computing devices that differ from what is illustrated in computing system architectures 200, 300, 400, and 500. Using FIG. 3 as an example, other embodiments of the computing system architecture 300 could have some of the sensors 308 as separate devices from the electronic user device 302. In particular, one of the sensors 308 can be an implanted sensor that monitors an organ and communicates information to the electronic user device 302 that has HBC capabilities. Conversely, the electronic user device 302 that has HBC capabilities may be implanted within the organ to monitor the organ and one of the sensors 308 is a separate device that connects the patient's skin to form the HBC channel. The use and discussion of FIGS. 2-5 are only examples to facilitate ease of description and explanation.

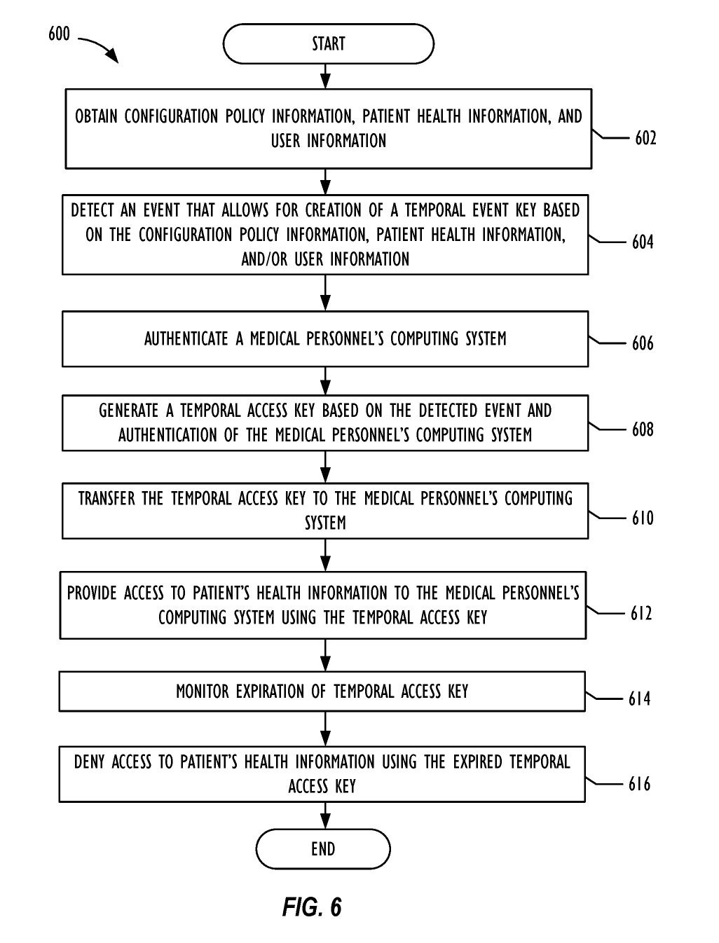

FIG. 6 is a flow chart of an embodiment of a method 600 to share a patient's medical information with authorized medical personnel. To share a patient's medical information, method 600 may generate a temporal access key within a TEE and share the temporal access key with authorized medical personnel. Using FIGS. 1-5 as an example, method 600 may be implemented using the computing system architecture 200, 300, 400, and 500 and/or within be one or more mobile devices 110, 112, and 114, and/or other types of HBC capable electronic user devices capable of connecting to computer network 102 and/or cellular network 103. Although FIG. 6 illustrates that the blocks of method 600 are implemented in a sequential operation, other embodiments of method 600 may have one or more blocks implemented in parallel operations.

Method 600 may start at block 602 to obtain configuration policy information, patient health information, and user information. The configuration policy information includes configuration policies that control the type of patient health information to expose and the expiration condition. User information includes information associated with a user, such as user location information and calendar information that could be relevant for detecting medical-based events. Method 600 may then move to block 604 to detect an event that allows for creation of a temporal event key based on the configuration policy information, patient health information, and user information. Examples of events that could allow for the creation of a temporal event key include, but are not limited to medical emergencies and/or scheduled medical visits.

Method 600 may continue to block 606 to authenticate a medical personnel's computing system. In one embodiment, method 600 may receive medical provider authentication information, such as a medical NPI, and locally authenticate the medical provider authentication information. For example, method 600 may query a remote computing service for an updated list of approved medical provider authentication information and subsequently locally store the updated list. When method 600 receives medical provider authentication information from the medical personnel's computing system, method 600 compares the received medical provider authentication information with the updated list. In another embodiment, method 600 may authenticate the medical personnel's computing system using a remote computing service, such as a medical cloud service.

Method 600 may then move to block 608 to generate a temporal access key based on the detected event and authentication of the medical personnel's computing system. Generation of the temporal access key may be dependent on where a patient's health information is stored. At block 606, method 600 may generate the temporal access key within a single electronic user device when relevant patient health information is accessed locally on the single electronic user device. Alternatively, if the relevant patient health information is stored on multiple computing devices, method 600 may generate the temporal access key based on assistance from the multiple computing device (e.g., a medical cloud service). The generated temporal access key may remain valid based on configuration policy information that defines a duration of time the generated temporal access key is valid for and/or any conditions that causes the temporal access key to expire.

Method 600 may then proceed to block 610 and transfer the temporal access key to the medical personnel's computing system. Afterwards, method 600 continues to block 612 and provides access to patient's health information to a medical personnel's computing system using the temporal access key. In one embodiment, the local electronic user device may provide the patient's health information. In another embodiment, the patient's health information may be provided by a remote computing service. Method 600 moves to block 614 and monitors expiration of the temporal access key. At block 614, method 600 may monitor whether a temporal access key expires based on the configuration policy information received in block 604. The configuration policy information may specify one or more locations the temporal access key becomes invalid (e.g., when entering the hospital the temporal access key will be dismissed), one or more locations the temporal access key remains valid (e.g., temporal access key remains valid only when a patient is at a specific medical facility), an amount of time the temporal access key remains valid (e.g., an hour) and/or the patient's current health condition (e.g., temporal access key becomes invalid if a patient is able to communicate or is out of danger). Once a temporal access key expires, method 600 may move to block 616 and deny access to patient's health information using the expired temporal access key. In one embodiment, the patient's health information may be deleted.

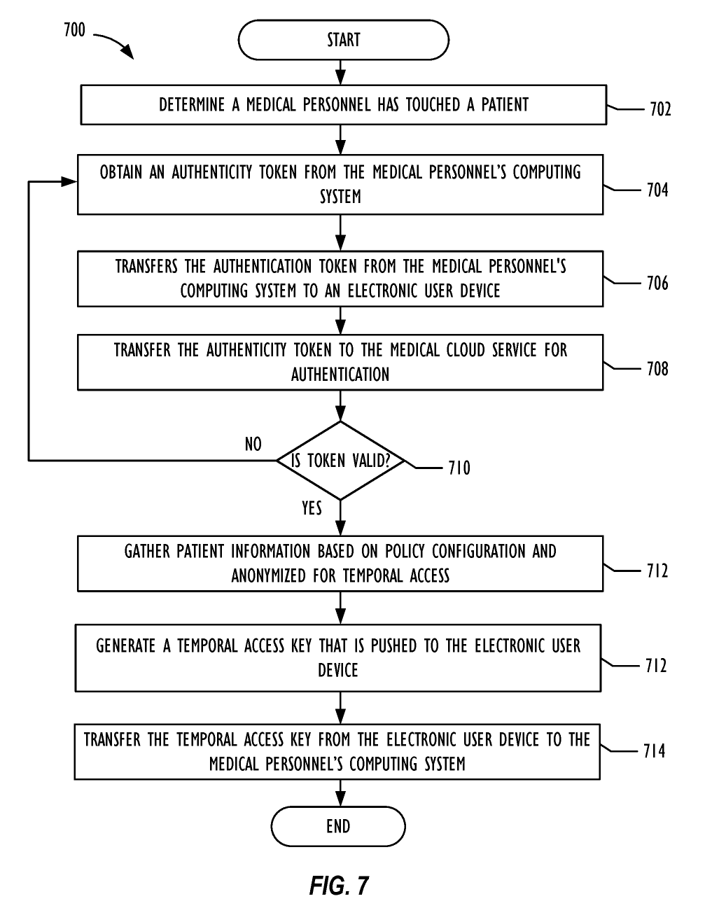

FIG. 7 is a flow chart of an embodiment of a method 700 to authenticate a medical personnel and generate a temporal access key using a medical cloud service. Specifically, method 700 provides an embodiment of how to implement blocks 606, 608, and 610 of FIG. 6. Method 700 starts at block 702 and determines that a medical personnel has touched a patient. Method 700 may move to block 704 and obtain an authenticity token from the medical personnel's computing system. In one embodiment, to obtain the authenticity token, the medical personnel's computing system may provide medical provider authentication information, such as a fingerprint scan and/or medical NPI number, to a medical cloud service to validate the medical personnel's computing system. Once validated, the medical cloud service generates and transfers the authenticity token back to the medical personnel's computing system.

Method 700 may then move to block 706 and transfers the authentication token from the medical personnel's computing system to an electronic user device. Afterwards, method 700 moves to block 708 and transfers the authenticity token to the medical cloud service for authentication. The method may then move to block 710 to determine whether the authenticity token transferred at block 708 is valid or not. If the authenticity token is invalid, method 700 moves back to block 704. Alternatively, if the authenticity token is valid, method 700 moves to block 712 to gather patient information based on policy configuration and anonymized for temporal access. To anonymize the patient information for temporal access, method 700 may remove and/or obscure personal identifiable information. Method 700 may then move to block 714 to generate a temporal access key that is pushed to the electronic user device. Method 700 may then move to block 716 and transfer the temporal access key from the electronic user device to the medical personnel's computing system.

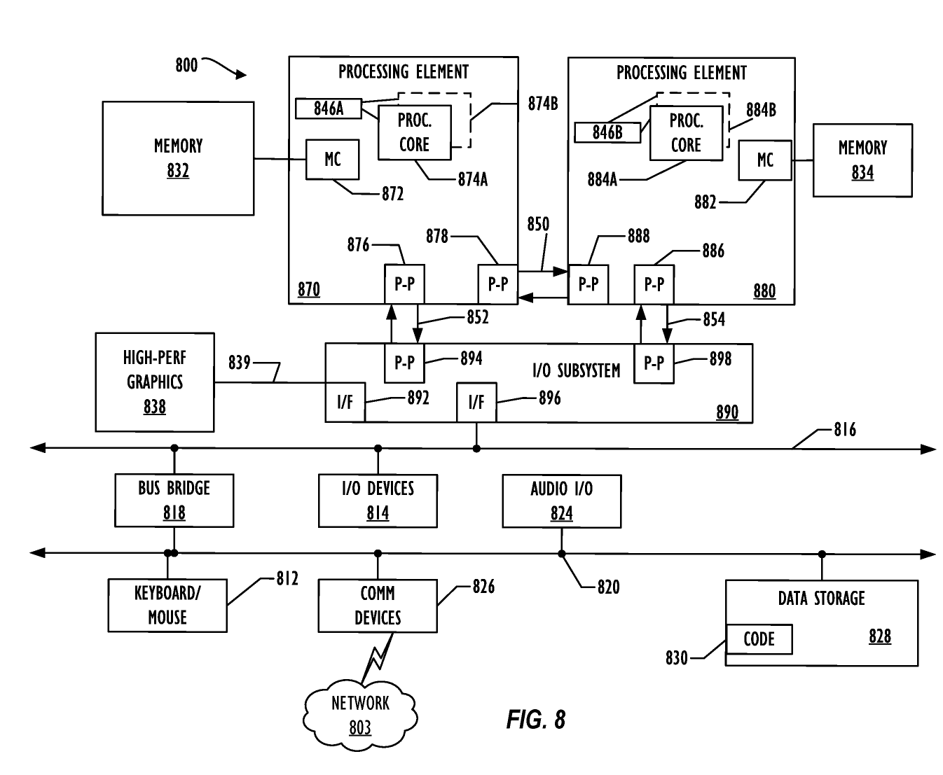

Referring now to FIG. 8, a block diagram illustrates a programmable device 800 that may be used for implementing the techniques described herein in accordance with one or more embodiments (e.g., computing system architecture 200 and method 600). The programmable device 800 illustrated in FIG. 8 is a multiprocessor programmable device that includes a first processing element 870 and a second processing element 880. While two processing elements 870 and 880 are shown, an embodiment of programmable device 800 may also include only one such processing element.

Programmable device 800 is illustrated as a point-to-point interconnect system, in which the first processing element 870 and second processing element 880 are coupled via a point-to-point interconnect 850. Any or all of the interconnects illustrated in FIG. 8 may be implemented as a multi-drop bus rather than point-to-point interconnects.

As illustrated in FIG. 8, each of processing elements 870 and 880 may be multicore processors, including first and second processor cores (i.e., processor cores 874a and 874b and processor cores 884a and 884b). Such cores 874a, 874b, 884a, 884b may be configured to execute computing instruction code. However, other embodiments may use processing elements that are single core processors as desired. In embodiments with multiple processing elements 870, 880, each processing element may be implemented with different numbers of cores as desired.

Each processing element 870, 880 may include at least one shared cache 846. The shared cache 846a, 846b may store data (e.g., computing instructions) that are utilized by one or more components of the processing element, such as the cores 874a, 874b and 884a, 884b, respectively. For example, the shared cache may locally cache data stored in a memory 832, 834 for faster access by components of the processing elements 870, 880. In one or more embodiments, the shared cache 846a, 846b may include one or more mid-level caches, such as level 2 (L2), level 3 (L3), level 4 (L4), or other levels of cache, a last level cache (LLC), or combinations thereof.

While FIG. 8 illustrates a programmable device with two processing elements 870, 880 for clarity of the drawing, the scope of the present invention is not so limited and any number of processing elements may be present. Alternatively, one or more of processing elements 870, 880 may be an element other than a processor, such as an graphics processing unit (GPU), a digital signal processing (DSP) unit, a field programmable gate array, or any other programmable processing element. Processing element 880 may be heterogeneous or asymmetric to processing element 870. There may be a variety of differences between processing elements 870, 880 in terms of a spectrum of metrics of merit including architectural, microarchitectural, thermal, power consumption characteristics, and the like. These differences may effectively manifest themselves as asymmetry and heterogeneity amongst processing elements 870, 880. In some embodiments, the various processing elements 870, 880 may reside in the same die package.

First processing element 870 may further include memory controller logic (MC) 872 and point-to-point (P-P) interconnects 876 and 878. Similarly, second processing element 880 may include a MC 882 and P-P interconnects 886 and 888. As illustrated in FIG. 8, MCs 872 and 882 couple processing elements 870, 880 to respective memories, namely a memory 832 and a memory 834, which may be portions of main memory locally attached to the respective processors. While MC logic 872 and 882 is illustrated as integrated into processing elements 870, 880, in some embodiments the memory controller logic may be discrete logic outside processing elements 870, 880 rather than integrated therein.

Processing element 870 and processing element 880 may be coupled to an I/O subsystem 890 via respective P-P interconnects 876 and 886 through links 852 and 854. As illustrated in FIG. 8, I/O subsystem 890 includes P-P interconnects 894 and 898. Furthermore, I/O subsystem 890 includes an interface 892 to couple I/O subsystem 890 with a high performance graphics engine 838. In one embodiment, a bus (not shown) may be used to couple graphics engine 838 to I/O subsystem 890. Alternately, a point-to-point interconnect 839 may couple these components.

In turn, I/O subsystem 890 may be coupled to a first link 816 via an interface 896. In one embodiment, first link 816 may be a Peripheral Component Interconnect (PCI) bus, or a bus such as a PCI Express bus or another I/O interconnect bus, although the scope of the present invention is not so limited.

As illustrated in FIG. 8, various I/O devices 814, 824 may be coupled to first link 816, along with a bridge 818 that may couple first link 816 to a second link 820. In one embodiment, second link 820 may be a low pin count (LPC) bus. Various devices may be coupled to second link 820 including, for example, a keyboard/mouse 812, communication device(s) 826 (which may in turn be in communication with the computer network 803), and a data storage unit 828 such as a disk drive or other mass storage device which may include code 830, in one embodiment. The code 830 may include instructions for performing embodiments of one or more of the techniques described above. Further, an audio I/O 824 may be coupled to second link 820.

Note that other embodiments are contemplated. For example, instead of the point-to-point architecture of FIG. 8, a system may implement a multi-drop bus or another such communication topology. Although links 816 and 820 are illustrated as busses in FIG. 8, any desired type of link may be used. In addition, the elements of FIG. 8 may alternatively be partitioned using more or fewer integrated chips than illustrated in FIG. 8.

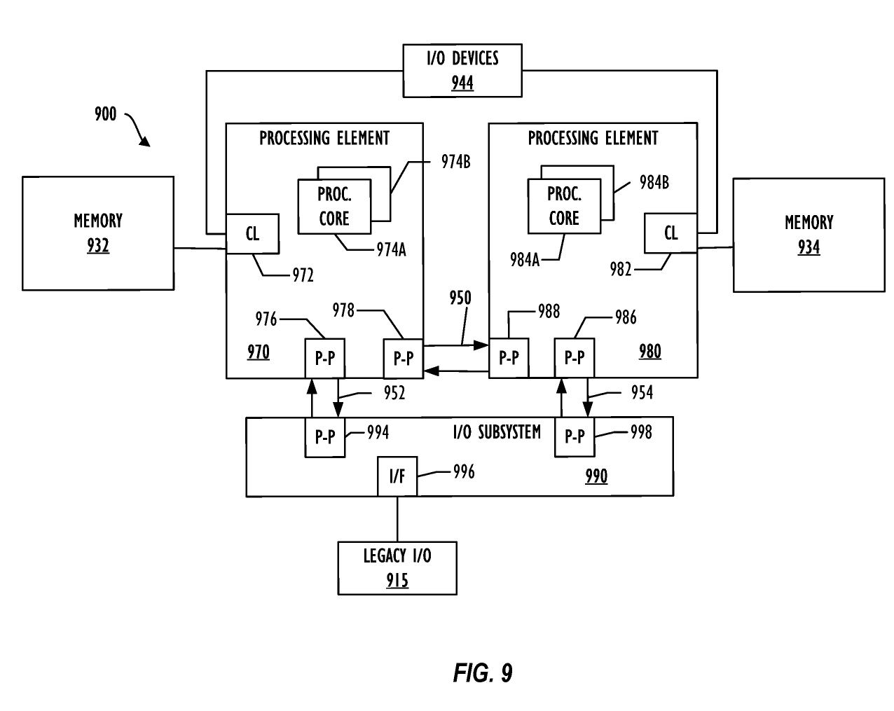

Referring now to FIG. 9, a block diagram illustrates a programmable device 900 according to another embodiment. Certain aspects of FIG. 9 have been omitted from FIG. 9 in order to avoid obscuring other aspects of FIG. 9.

FIG. 9 illustrates that processing elements 970, 980 may include integrated memory and I/O control logic (“CL”) 972 and 982, respectively. In some embodiments, the 972, 982 may include memory control logic (MC) such as that described above in connection with FIG. Error! Reference source not found. In addition, CL 972, 982 may also include I/O control logic. FIG. Error! Reference source not found. illustrates that not only may the memories 932, 934 be coupled to the CL 972, 982, but also that I/O devices Error! Reference source not found.44 may also be coupled to the control logic 972, 982. Legacy I/O devices 915 may be coupled to the I/O subsystem 990 by interface 996. Each processing element 970, 980 may include multiple processor cores, illustrated in FIG. 9 as processor cores 974A, 974B, 984A and 984B. As illustrated in FIG. Error! Reference source not found., I/O subsystem 990 includes point-to-point (P-P) interconnects 994 and 998 that connect to P-P interconnects 976 and 986 of the processing elements 970 and 980 with links 952 and 954. Processing elements 970 and 980 may also be interconnected by link 950 and interconnects 978 and 988, respectively.

The programmable devices depicted in FIGS. 8 and 9 are schematic illustrations of embodiments of programmable devices that may be utilized to implement various embodiments discussed herein. Various components of the programmable devices depicted in FIGS. 8 and 9 may be combined in a system-on-a-chip (SoC) architecture.

Program instructions may be used to cause a general-purpose or special-purpose processing system that is programmed with the instructions to perform the operations described herein. Alternatively, the operations may be performed by specific hardware components that contain hardwired logic for performing the operations, or by any combination of programmed computer components and custom hardware components. The methods described herein may be provided as a computer program product that may include a machine readable medium having stored thereon instructions that may be used to program a processing system or other electronic device to perform the methods. The term “machine readable medium” used herein shall include any medium that is capable of storing or encoding a sequence of instructions for execution by the machine and that cause the machine to perform any one of the methods described herein. The term “machine readable medium” shall accordingly include, but not be limited to, tangible, non-transitory memories such as solid-state memories, optical and magnetic disks. Furthermore, it is common in the art to speak of software, in one form or another (e.g., program, procedure, process, application, module, logic, and so on) as taking an action or causing a result. Such expressions are merely a shorthand way of stating that the execution of the software by a processing system causes the processor to perform an action or produce a result.

At least one embodiment is disclosed and variations, combinations, and/or modifications of the embodiment(s) and/or features of the embodiment(s) made by a person having ordinary skill in the art are within the scope of the disclosure. Alternative embodiments that result from combining, integrating, and/or omitting features of the embodiment(s) are also within the scope of the disclosure. Where numerical ranges or limitations are expressly stated, such express ranges or limitations may be understood to include iterative ranges or limitations of like magnitude falling within the expressly stated ranges or limitations (e.g., from about 1 to about 10 includes, 2, 3, 4, etc.; greater than 0.10 includes 0.11, 0.12, 0.13, etc.). The use of the term “about” means ±10% of the subsequent number, unless otherwise stated.

Use of the term “optionally” with respect to any element of a claim means that the element is required, or alternatively, the element is not required, both alternatives being within the scope of the claim. Use of broader terms such as comprises, includes, and having may be understood to provide support for narrower terms such as consisting of, consisting essentially of, and comprised substantially of Accordingly, the scope of protection is not limited by the description set out above but is defined by the claims that follow, that scope including all equivalents of the subject matter of the claims. Each and every claim is incorporated as further disclosure into the specification and the claims are embodiment(s) of the present disclosure.

The following examples pertain to further embodiments.

Example 1 is a machine readable medium on which instructions are stored, comprising instructions that when executed cause a machine for sharing patient health information to: generate a temporal access key based on a detection of an event and one or more configuration policies associated with a patient, wherein the temporal access key provides access to the patient's health information; transfer the temporal access key via a communication channel to a medical personnel's computing system after authenticating the medical personnel's computing system, wherein the patient's body is part of the communication channel; and invalidate the temporal access key after detecting an expiration condition, wherein the one or more configuration policies control the type of health information the temporal access key exposes to the medical personnel's computing system and determines the expiration condition.

In Example 2, the subject matter of Example 1 can optionally include instructions that the instructions further comprise instructions that when executed cause the machine to: receive a medical national provider identifier from the medical personnel's computing system; and forward the medical national provider identifier to a remote computing service to authenticate the medical personnel's computing system.

In Example 3, the subject matter of Example 1 can optionally include that the instructions further comprise instructions that when executed cause the machine to: receive a medical national provider identifier from the medical personnel's computing system; and forward the medical national provider identifier to a remote computing service to authenticate the medical personnel's computing system.

In Example 4, the subject matter of any preceding Examples can optionally include that the communication channel is a HBC based channel.

In Example 5, the subject matter of any preceding Examples can optionally include that the generation of a temporal access key occurs within a hardware security and management engine.

In Example 6, the subject matter of any preceding Examples can optionally include that the instructions further comprise instructions that when executed cause the machine to detect the event that allows for generation of the temporal access key.

In Example 7, the subject matter of Example 6 can optionally include that the instructions to detect the event comprise instructions that when executed cause the machine to: obtain a patient's health information; determine whether a health emergency exists for a patient based on the patient's health information; and generate a notification based on the determination that the health emergency exists.

In Example 8, the subject matter of Example 6 or 7 can optionally include that the instructions to detect the event comprise instructions that when executed cause the machine to: obtain user location information and user calendar information; determine whether a patient is at a medical facility for a scheduled medical visit based on the user location information and the user calendar information; and generate a notification based on the determination that the patient is at the medical facility for the scheduled medical visit.

In Example 9, the subject matter of any preceding Examples can optionally include that the instructions further comprise instructions that when executed cause the machine to categorize the patient's health information into a plurality of levels based on the one or more configuration policies, and wherein the levels correspond to the type of health information the temporal access key exposes to the medical personnel's computing system.

In Example 10, the subject matter of Example 9 can optionally include that a first level of the plurality of levels includes real-time vital information, and wherein a second level of the plurality of levels includes a patient's electronic health records.

In Example 11, the subject matter of any preceding Examples can optionally include that the one or more configuration policies determines the expiration condition based on a determination that the event that allowed the generation of the temporal access key no longer exists.

Example 12 includes a system for sharing patient health information, comprising: at least one processor; and a memory, coupled to the at least one processor, on which are stored instructions comprising instructions that when executed by the at least one processor cause the at least one processor to: generate a temporal access key based on a detection of an event and one or more configuration policies associated with a patient; transfer the temporal access key via a communication channel to a medical personnel's computing system after authenticating the medical personnel's computing system, wherein the patient's body is part of the communication channel; and provide access to the patient's health information to the medical personnel's computing system after receiving the temporal access key from the medical personnel's computing system, wherein the one or more configuration policies control the type of health information the temporal access key exposes to the medical personnel's computing system and how the temporal access key expires.

In Example 13, the subject matter of Example 12 can optionally include that the instructions further comprise instructions that when executed by the at least one processor cause the at least one processor to: receive a medical national provider identifier from the medical personnel's computing system; and forward the medical national provider identifier to a remote computing service to authenticate the medical personnel's computing system.

In Example 14, the subject matter of Example 12 can optionally include that the instructions further comprise instructions that when executed by the at least one processor cause the at least one processor to: receive a medical national provider identifier from the medical personnel's computing system; and authenticate the medical personnel's computing system based on the received medical national provider identifier.

In Example 15, the subject matter of Example 14 can optionally include that the instructions to authenticate a medical personnel's computing system comprise instructions that when executed by the at least one processor cause the at least one processor to compare an updated list of authorized medical providers with the received medical national provider identifier.

In Example 16, the subject matter of any of the Examples 12-15 can optionally include that the generation of the temporal access key occurs within a hardware security and management engine.

In Example 17, the subject matter of any of the Examples 12-15 can optionally include that the instructions further comprise instructions that when executed by the at least one processor cause the at least one processor to categorize the patient's health information into a plurality of levels based on the one or more configuration policies, and wherein the levels correspond to the type of health information the temporal access key exposes to the medical personnel's computing system.

Example 18, includes a method for sharing patient health information, comprising: generating a temporal access key based on a detection of an event and one or more configuration policies associated with a patient, wherein the temporal access key provides access to the patient's health information; transferring the temporal access key via a communication channel to a medical personnel's computing system after authenticating the medical personnel's computing system, wherein the patient's body is used to form part of the communication channel; and invalidating the temporal access key after detecting an expiration condition, wherein the one or more configuration policies control the type of health information the temporal access key exposes to the medical personnel's computing system and determines the expiration condition.

In Example 19, the subject matter of Example 18 can optionally include detecting the event that allows for the generation of the temporal access key.

In Example 20, the subject matter of Example 19 can optionally include that detecting the event further comprises: obtaining the patient's health information; determining whether a health emergency exists for the patient based on the patient's health information; and generating a notification based on the determination that the health emergency exists.

In Example 21, the subject matter of Example 19 can optionally include that detecting the event further comprises: obtaining user location information and user calendar information; determining whether the patient is at a medical facility for a scheduled medical visit based on the user location information and the user calendar information; and generating a notification based on the determination that the patient is at the medical facility for the scheduled medical visit.

In Example 22, the subject matter of any of Examples 18-21 can optionally include categorizing the patient's health information into a plurality of levels based on the one or more configuration policies, wherein the levels correspond to the type of health information the temporal access key exposes to the medical personnel's computing system.

In Example 23, the subject matter of Example 22 can optionally include that a first level of the plurality of levels includes real-time vital information, and wherein a second level of the plurality of levels includes a patient's electronic health records.

In Example 24, the subject matter of any of Examples 18-22 optionally include that the one or more configuration policies control determines the expiration condition based on a determination that the event that allows for the generation of the temporal access key no longer exists.

Example 25 includes an apparatus for sharing patient health information, comprising means to perform the steps of the machine readable medium of any one of the Examples 1-11.

Example 26 includes a method for sharing patient health information that performs the steps of the system of any one of the Examples 1-11.

Example 27 for sharing patient health information comprising: at least one processor; and at least one memory, coupled to the at least one processor, and comprises instructions, when executed by the at least one processor, causes the system to perform the steps of the machine readable medium of any one of the Examples 1-11.

It is to be understood that the above description is intended to be illustrative, and not restrictive. For example, the above-described embodiments may be used in combination with each other. Many other embodiments will be apparent to those of skill in the art upon reviewing the above description. The scope of the invention therefore should be determined with reference to the appended claims, along with the full scope of equivalents to which such claims are entitled. It should be noted that the discussion of any reference is not an admission that it is prior art to the present invention, especially any reference that may have a publication date after the priority date of this application.

What is claimed is:

1. A machine readable medium on which instructions are stored, comprising instructions that when executed cause a machine for sharing patient health information to:
generate a temporal access key based on a detection of an event and one or more configuration policies associated with a patient, wherein the temporal access key provides access to the patient's health information;
transfer the temporal access key via a communication channel to a medical personnel's computing system after authenticating the medical personnel's computing system, wherein the patient's body is part of the communication channel; and
invalidate the temporal access key after detecting an expiration condition, wherein the one or more configuration policies control the type of health information the temporal access key exposes to the medical personnel's computing system and determines the expiration condition.

2. The machine readable medium of claim 1, wherein the instructions further comprise instructions that when executed cause the machine to:
receive a medical national provider identifier from the medical personnel's computing system; and
forward the medical national provider identifier to a remote computing service to authenticate the medical personnel's computing system.

3. The machine readable medium of claim 1, wherein the instructions further comprise instructions that when executed cause the machine to:
receive a medical national provider from the medical personnel's computing system; and
authenticate the medical personnel's computing system based on the received medical national provider identifier.

4. The machine readable medium of claim 1, wherein the communication channel is a Human Body Communication based channel.

5. The machine readable medium of claim 1, wherein the generation of a temporal access key occurs within a hardware security and management engine.

6. The machine readable medium of claim 1, wherein the instructions further comprise instructions that when executed cause the machine to detect the event that allows for generation of the temporal access key.

7. The machine readable medium of claim 6, wherein the instructions to detect the event comprise instructions that when executed cause the machine to:
obtain a patient's health information;
determine whether a health emergency exists for a patient based on the patient's health information; and
generate a notification based on the determination that the health emergency exists.

8. The machine readable medium of claim 6, wherein the instructions to detect the event comprise instructions that when executed cause the machine to:
obtain user location information and user calendar information;
determine whether a patient is at a medical facility for a scheduled medical visit based on the user location information and the user calendar information; and
generate a notification based on the determination that the patient is at the medical facility for the scheduled medical visit.

9. The machine readable medium of claim 1, wherein the instructions further comprise instructions that when executed cause the machine to categorize the patient's health information into a plurality of levels based on the one or more configuration policies, and wherein the levels correspond to the type of health information the temporal access key exposes to the medical personnel's computing system.

10. The machine readable medium of claim 9, wherein a first level of the plurality of levels includes real-time vital information, and wherein a second level of the plurality of levels includes a patient's electronic health records.

11. The machine readable medium of claim 1, wherein the one or more configuration policies determines the expiration condition based on a determination that the event that allowed the generation of the temporal access key no longer exists.

12. A system for sharing patient health information, comprising:
at least one processor; and
a memory, coupled to the at least one processor, on which are stored instructions comprising instructions that when executed by the at least one processor cause the at least one processor to:
generate a temporal access key based on a detection of an event and one or more configuration policies associated with a patient;
transfer the temporal access key via a communication channel to a medical personnel's computing system after authenticating the medical personnel's computing system, wherein the patient's body is part of the communication channel; and
provide access to the patient's health information to the medical personnel's computing system after receiving the temporal access key from the medical personnel's computing system,
wherein the one or more configuration policies control the type of health information the temporal access key exposes to the medical personnel's computing system and how the temporal access key expires.

13. The system of claim 12, wherein the instructions further comprise instructions that when executed by the at least one processor cause the at least one processor to:
receive a medical national provider identifier from the medical personnel's computing system; and
forward the medical national provider identifier to a remote computing service to authenticate the medical personnel's computing system.

14. The system of claim 12, wherein the instructions further comprise instructions that when executed by the at least one processor cause the at least one processor to:
receive a medical national provider identifier from the medical personnel's computing system; and
authenticate the medical personnel's computing system based on the received medical national provider identifier.

15. The system of claim 14, wherein the instructions to authenticate a medical personnel's computing system comprise instructions that when executed by the at least one processor cause the at least one processor to compare an updated list of authorized medical providers with the received medical national provider identifier.

16. The system of claim 12, wherein the generation of the temporal access key occurs within a hardware security and management engine.

17. The system of claim 12, wherein the instructions further comprise instructions that when executed by the at least one processor cause the at least one processor to categorize the patient's health information into a plurality of levels based on the one or more configuration policies, and wherein the levels correspond to the type of health information the temporal access key exposes to the medical personnel's computing system.

18. A method for sharing patient health information, comprising:
generating a temporal access key based on a detection of an event and one or more configuration policies associated with a patient, wherein the temporal access key provides access to the patient's health information;
transferring the temporal access key via a communication channel to a medical personnel's computing system after authenticating the medical personnel's computing system, wherein the patient's body is used to form part of the communication channel; and
invalidating the temporal access key after detecting an expiration condition,
wherein the one or more configuration policies control the type of health information the temporal access key exposes to the medical personnel's computing system and determines the expiration condition.

19. The method of claim 18, further comprising detecting the event that allows for the generation of the temporal access key.

20. The method of claim 19, wherein detecting the event further comprises:
obtaining the patient's health information;
determining whether a health emergency exists for the patient based on the patient's health information; and
generating a notification based on the determination that the health emergency exists.

21. The method of claim 19, wherein detecting the event further comprises:
obtaining user location information and user calendar information;
determining whether the patient is at a medical facility for a scheduled medical visit based on the user location information and the user calendar information; and
generating a notification based on the determination that the patient is at the medical facility for the scheduled medical visit.

22. The method of claim 18, further comprising categorizing the patient's health information into a plurality of levels based on the one or more configuration policies, wherein the levels correspond to the type of health information the temporal access key exposes to the medical personnel's computing system.

23. The method of claim 22, wherein a first level of the plurality of levels includes real-time vital information, and wherein a second level of the plurality of levels includes a patient's electronic health records.

24. The method of claim 18, wherein the one or more configuration policies control determines the expiration condition based on a determination that the event that allows for the generation of the temporal access key no longer exists.
